(19) United States
(12) Patent Application Publication
(10) Pub. No.: US 2018/0232806 A1
(43) Pub. Date: Aug. 16, 2018

(54) TRADING PLATFORM SYSTEMS AND METHODS

(71) Applicant: SIX CAPITAL PTE LTD., Singapore (SG)

(72) Inventor: Chee Wai TENG, Singapore (SG)

(21) Appl. No.: 15/516,644

(22) PCT Filed: Oct. 4, 2015
(86) PCT No.: PCT/SG2015/050369

§ 371 Date: Apr. 3, 2017

(30) Foreign Application Priority Data
Oct. 4, 2014 (SG) 10201406360T

(51) Int. Cl. G06Q 40/04; G06N 7/02; G06Q 40/06; H04L 29/08

(52) U.S. Cl. CPC G06Q 40/04; H04L 67/1002; G06Q 40/06; G06N 7/02

(57) ABSTRACT

A crowd sourcing, knowledge-harvesting trading platform collects big data from many trader computing devices that place demo trades. The trading platform copies the high probability winning trades from a demo account into the live markets for execution.

### TECHNICAL FIELD

This application relates generally to an electronic trading platform.

### BACKGROUND

Funds or products are traditionally evaluated and managed by a portfolio manager, a trader, or an analyst. An investment decision is conventionally performed by a person, so the final input into an investment decision is a human input. As a result, the investment decisions that are derived from human inputs have the risk of emotions and irrationality.

As another drawback to conventional investments, investors do not have access to investment products that provide both capital guarantee and high returns at the same time. Also, investors may not have access to traders who are passionate to learn trading, which can often take years and decades, losing money in the midst of learning.

Because of these drawbacks, conventional investment products may not offer a high rate of return (e.g., 18% per annum) with capital guaranteed on that investment. In fact, about 85% of current retail traders (i.e., speculators) lose money on their transactions.

In one conventional solution, funds can solely trade via an algorithm or “black-box trading.” These funds used computational finance and high frequency trading technology to analyze opportunities in the market and execute trades. This method of fund management does solve the risk of emotions and irrationality when performing investment decisions. There is also a large component of market sentiment in the financial markets. As such, the market is constantly evolving and technology, but no matter how superior it is, it cannot evolve simultaneously to keep pace with market evolution.

Because of the constraints of the Dodd Frank Act and Basel III, bankers are not taking on as much risk and are unable to speculate trading positions. Previously, banks used depositors' credit to speculate trading positions. However, Basel III and the Dodd Frank Act prohibits this speculation because it poses risk on the depositors. As a result, some of the largest banks in the world will not take on risk anymore, and the alternative is to take on the business of brokerage services instead.

When the largest banks become brokers, the proprietary traders must evolve to become FX price-makers in the buy-side of the industry. Because if the customers do not know the proper method of trading, the broker can no longer provide prices, find a large number of customers, and make money when the customer trades. Instead, the customers may only conduct one transaction and then sit on it for weeks, usually losing money in that transaction.

When a financial instrument has an underlying physical asset, there is a basis to analyze the asset. Foreign exchange, however, does not have a physical asset, so there is no basis for analysis. Yet retail traders may still analyze the foreign exchange market as they do in equity markets. Moreover, the retail traders tend to hold positions for 10 pip movement, which is inevitably difficult. As a result, most retail trades are not able to trade profitably on a consistent basis.

There are disadvantages to the conventional solutions. When a trader invests his/her own money, if the market goes in the trader's favor, then the trader tends to be greedy, whereas if the market goes against the trader, then the trader tends to be fearful. It is desirable to have a solution that is not affected by these human emotions.

Further, conventional systems rely upon automatically submitting trades inputted by traders who may specialize in a particular currency. However, the trader may not be profitable when trading in that currency throughout the day and in all market conditions. Yet these automated systems continue to submit the trades on a live market without consideration of these factors. It is desirable to have a solution that offers a more efficient computer-based system for placing trades in the most optimal conditions.

### SUMMARY

The systems and methods disclosed herein seek to address the problems described above and may provide a number of other advantages. For example, the systems and methods described herein aim to integrate the human input and technology input into every investment decision taken; achieve small but consistent profits; have trading performance be independent of only a small group of high performing traders; limit holding time to limit exposure to the market; isolate emotional stress of greed and fear from the traders; deliver investment products packaged in a unique structure that caters for the investors expecting capital guarantee and speculators who are willing to take risk for higher returns; allow a trader to master the skill of price action trading within a short time frame. As described in the exemplary embodiments, all traders execute all trades on demo accounts using price action methodology, they focus on making small and consistent winning trades under all market conditions, and the algorithm can map the market conditions to characteristics of the trader in an attempt to guarantee high tagging win rate and profit.

As described herein, a crowd sourcing, knowledge-harvesting trading platform collects big data from many trader computing devices that place demo trades. The trading platform copies the high probability winning trades from a demo account into the live markets for execution. The trading platform aims to strategically combine human input and technology input into every investment decision taken; train traders to look for market opportunities within a short time (e.g., 90 seconds); incorporate price action trading methodology; allow traders to trade on demo accounts, capture details of all the traders and grade individual trades based on key performance indicators, map the performance characteristics of the trader using big data analytics, execute trades selected from the big data analytics in a live market, map the conditions of the market using an algorithm, segment profits to different classes of speculators, and provide an optimum medium for trading leveraged funds. By determining a market condition and then dynamically selecting the inputted trades of those traders with the highest likelihood of success at that particular market condition, the system can optimize the efficiency and profitability.

In one embodiment, a computer-implemented method comprises receiving, by a server, an input transmitted from each of a plurality of trader computing devices comprising a message having data representing a prediction of a market trend and a proposed trade, wherein the input is transmitted within a predetermined time increment; storing, by the server, each proposed trade in a record of a demo account in a database communicatively coupled to the server, wherein the proposed trade is associated in the record with a trader and the time increment; determining, by the server, a likelihood that the received prediction is correct and a current market condition for the time increment; dynamically selecting, by the server, a set of records in the demo account associated with each trader that has a likelihood above a threshold amount for a profitable trade in the determined market condition and based upon the likelihood that the received prediction is correct and historical behavioral data of each trader; automatically adjusting, by the server, the record of the proposed trade in the demo account to a trade in a live account for executing in a market; and generating, by the server, an instruction to execute the trade from the live account.

In another embodiment, a computer-implemented method comprises determining, by a server, characteristics of each of a plurality of traders to determine characteristics of each of the plurality of traders when those traders have the highest probability of entering a profitable trade; determining, by the server, a present market condition; analyzing, by the server, which trader of the plurality of traders has the highest probability of entering a profitable trade in the determined present market condition: and automatically presenting, by the server, a set of data in at least three timeframes for display on a graphical user interface of a trader computing device; receiving, by the server, an input of data representing a trade from each of a plurality of trader computers; dynamically selecting, by the server, a subset of the plurality of traders for entering live trades based on the trade inputted from the trader computers when the determined present market condition matches characteristics of the subset of the plurality of traders; and generating and transmitting, by the server, an instruction to enter the live trades.

In yet another embodiment, a computer-implemented method comprises determining, by a server, a subset of a set of trades inputted during a trading session of a predetermined time increment that have a high probability of being a profitable trade in a particular market condition; receiving, by the server, a message from at least one speculator computing device to commit funds of a speculator for the trading session having the subset of the set of trades; entering, by the server, the subset of the set of trades in a market; computing, by the server, a profit or loss for the subset of the set of trades entered in the market; and automatically allocating, by the server, the profit or loss for the subset of the set of trades to the at least one speculator based upon the funds committed by the speculator.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates a system architecture according to an exemplary embodiment.

FIG. 2 illustrates a trading platform module architecture according to an exemplary embodiment.

FIG. 3 illustrates a method of transmitting trades to a trading platform module according to an exemplary embodiment.

FIG. 4 illustrates a method of executing an algorithm on a trading platform module according to an exemplary embodiment.

### DETAILED DESCRIPTION OF THE DRAWINGS

In the following detailed description of non-limiting, illustrative embodiments, reference is made to the accompanying drawings that form a part hereof. Other embodiments may be utilized, and logical, structural, mechanical, or electrical changes may be made without departing from the scope of the appended claims. To avoid details not necessary to enable those skilled in the art to practice the embodiments described herein, the description may omit certain information known to those skilled in the art. The following detailed description is non-limiting, and the scope of the illustrative embodiments are defined by the appended claims.

A utility trading system 110 comprises a plurality of trader computing devices 120a, 120b, 120c, and a utility trading server 130. Each trader computing device 120a, 120b, 120c can be associated with a trader. The trader computing devices 120a, 120b, 120c can be a networked computer, such as a personal computer, desktop computer, laptop computer, tablet computer, smart phone, mobile phone, personal data assistant, or the like. Each trader computing device 120a, 120b, 120c has a graphical user interface that can be presented on a display or screen of the trader computing device 120a, 120b, 120c for interaction with a trader. Also, each trader computing device 120a, 120b, 120c has a processor that executes instructions stored on a computer-readable medium.

The trader computing device 120a, 120b, 120c can also be communicatively coupled to other components of the system. The trader computing devices can transmit information to and from the utility trading server 130 over a network (e.g., wired, wireless, public, or private). For example, a trader can use a graphical user interface on the trading computing device 120a, 120b, 120c to enter a trade, which is transmitted to the utility trader server 130.

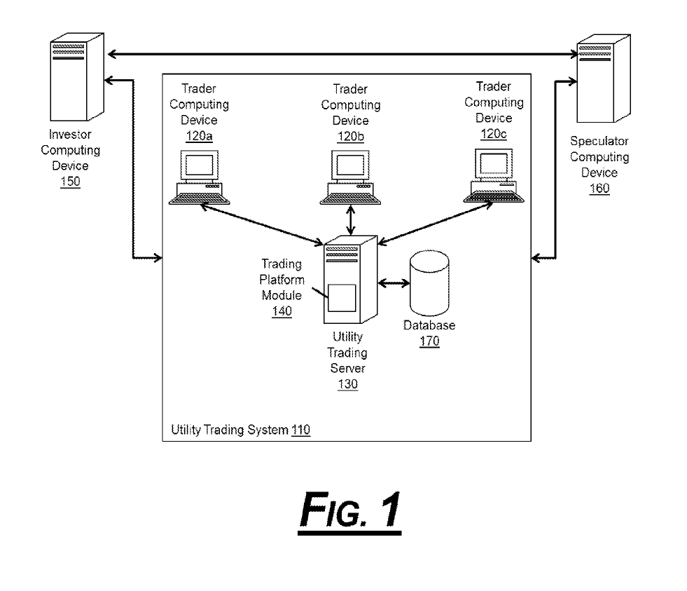

Although only three trader computing devices 120a, 120b, 120c are shown in FIG. 1, it is intended that any number of trader computing devices can be used. It may be preferable to include more trader computing devices to obtain a larger set of data, as discussed below. In one example, the system may comprise over 10,000 trader computing devices, though any number of trader computing devices may be used.

An exemplary embodiment recites the input, transmission, analysis, execution, entry, and exit of a trade. The trade may be a transaction for foreign exchange market (“forex”) or currency market trading, equity and debt (e.g., stocks, bonds) trading, commodity trading, derivative trading, futures contract trading, exchange traded funds (ETFs), exchange traded notes (ETNs), real estate investment trusts (REITs), U.S. Government treasury trading, or any other financial instrument. In the exemplary embodiment, the trade is a forex trade. Unlike other financial instruments, currency trading is not based upon an underlying physical asset that can be affected by factors such as weather. Also, forex does not have an exchange, rather it is a transaction between two parties in a counterparty marketplace. Although the exemplary embodiment recites the use of a forex trade, the utility trading system and method described herein can be applied to any financial instrument trading.

In one embodiment where the trade is for the forex market, the utility trading server 130 transmits information for display on a graphical user interface on the trader computing device 120a, 120b, 120c. In the exemplary embodiment, the information for display to the trader includes historical data in a plurality of timeframes of a selected financial instrument or multiple financial instruments (e.g., two currencies in a trading pair).

The historical data can include real-time data and recently-executed transactions. The utility trading server 130 queries a database 170 for this historical data in the timeframes for the selected financial instrument. As the database 170 is updated with new transactions, the utility trading server 130 automatically updates the graphical user interface on the trader computing device 120a, 120b, 120c to present substantially-real time information in the desired timeframes. For example, in a one minute timeframe, the graphical user interface will display transactions for that particular instrument in the latest one minute, and the graphical user interface will continuously update with new data.

In the exemplary embodiment, the utility trading system 110 presents three timeframes to each trader computing device 120a, 120b, 120c, though any number of timeframes may be used. The graphical user interface presents the three different timeframes of transactions for the same financial instrument. The graphical user interface can provide a precise interpretation of a trend in the market and why it is showing a particular trend. The timeframes may range from about five seconds to about one week. In one example, a first timeframe is ten seconds, a second timeframe is one minute, and a third time frame is ten minutes. Other embodiments may use different timeframes and a different number of timeframes on the graphical user interface. These timeframes may be used to determine a pattern and/or whether a trend is emerging, such as a direction upwards or downwards. The trade may be placed based upon the pattern/trend or a change in the pattern/trend. In one embodiment, the trader submits a trade on the trader computing device 120a, 120b, 120c when the three timeframes show the same trend (e.g., all show an upward or all show a downward trend). In an alternative embodiment, the trade may be placed automatically or by an algorithm when the three timeframes satisfy a predetermined condition.

The timeframes can be displayed on a graphical user interface of the trader computing device 120a, 120b, 120c in multiple layers or dimensions. The graphical user interface presents a first layer that represents the first timeframe (e.g., 10 seconds). A second layer is presented on the first layer, and the second layer represents the second timeframe (e.g., one minute). A third layer is presented on the second layer, and the third layer represents the third timeframe (e.g., 10 minutes). In one embodiment, the layers may be overlaid in a manner that each layer is integrated into a single layer that presents the data representing the three timeframes. For example, a graph may show the data on three scales, where each scale represents a timeframe. In another example, the graph may show the data on one scale, where the scale represents the largest timeframe. In yet another example, the graph may show the data on one scale, and the scale is a log-based scale of the largest timeframe. In another embodiment, the second layer and the third layer may be translucent, and when overlaid on the first layer, each of the three timeframes will remain visible.

The trader computing devices 120a, 120b, 120c present the graphical user interface on a display and receive an input from the trader representing when to enter a trade for a particular currency or other financial instrument. The traders may implement price action trading, whereby the traders may make trading decisions based on the actual price movement shown on the charts on the graphical user interface. For example, when the market appears to be heading in an upward direction, the trader may be more aggressive and buy in that transaction. And when the market appears to be heading in a downward direction, the trader may be more defensive and sell in that transaction.

The utility trading server 130 is configured to receive and transmit information to and from the trader computing devices 120a, 120b, 120c. The utility trading server 130 can collect trades from the plurality of trader computing devices 120a, 120b, 120c. Although the exemplary embodiment shows the utility trading server 130 as a single server, it is intended that the utility trading server 130 can be one or more servers and may be communicatively coupled to one or more databases, which can be implemented within the utility trading server or as a separate component.

The utility trading server 130 has a trading platform module 140. In the exemplary embodiment, the trading platform module 140 comprises specially-programmed computer-readable instructions that are stored on the utility trading server 130 and executed by a processor of the utility trading server 130. Although described herein as a single module capable of various functions, the trading platform module 140 can also comprise more than one module, whereby each module can perform a particular function. For example, one module or component of the trading platform module 140 can perform analytics on the trades and traders, and another module or component of the trading platform module 140 can enter demo trades into the live market. In other embodiments, the trading platform module 140 can be configured as a separate server that is communicatively coupled to the utility trading server 130. The trading platform module 140 can operate for trading currencies as well as other financial asset classes, e.g., gold, stock indices, commodities, etc.

Trades transmitted from the trader computing devices 120a, 120b, 120c to the utility trading server 130 can be processed individually, in batches, or all at once by the trading platform module 140. Also, the trades from the utility trading server 130 can be processed by the trading platform module 140 on a real-time or periodic basis (e.g., every 5 seconds, 10 seconds, 30 seconds, 1 minute, 90 seconds, 10 minutes, 30 minutes).

Many large banks assess the profitability of their positions for the first 60 seconds and if not profitable, they will liquidate their position within 90 seconds. Hence, after 90 seconds, the market will move against the previous direction and will revert a loss for any positions maintained after 90 seconds. As a result, a strategy of buying at lowest and selling at highest or vice-versa does not exist anymore. By holding the position over 90 seconds, the retail traders mostly incur a loss that initially was a profitable position, because many large banks liquidate their positions. So the trading platform described herein can limit the holding period (e.g., limited to 90 seconds) in an attempt to limit the exposure to the market. The trading platform can enter and exit a position in short term forex trading within 90 seconds based upon price action. The trading platform module utilizes a clock internal to the trading platform server, and upon entering a position, the trading platform module will set a trigger such that the trading platform module will automatically instruct an exit of the position within 90 seconds from the initial entrance time.

The trading platform module 140 may implement a trading time limit (e.g., 30 seconds, 60 seconds, 90 seconds). In an exemplary embodiment, the trading platform module 140 has a 90 second trading limit, so all trades must be closed within 90 seconds of being executed. When a trade is closed on the live market, then the position is exited from the market and the capital associated with that trade is no longer at risk. The trading platform module 140 can implement a stop loss. For example, a stop loss may be set at −2 pips (a pip is the smallest price change that a given exchange rate can make), so a loss on a particular trade is limited to only 2 pips. Once the trade reaches the stop loss position (e.g., −2 pips), the trading platform module 140 automatically closes the trade. Alternatively, once the trade reaches a desired profit, the trading platform module 140 can automatically close the trade. In yet another alternative, the trading platform module 140 can automatically close the trade after 90 seconds if it has not yet reached a maximum loss or desired profit. So if the trade does not get closed out, then the trading platform module 140 will automatically close it.

The trading platform module 140 can divide the market into increments of time, such as 30 minute increments. During the session lasting for that time increment, the trading platform module 140 may give a limited amount of opportunities for the trader to submit a proposed trade using the graphical user interface on the trader computing devices 120a, 120b, 120c. In an exemplary embodiment, the trader can submit only one trade in the time increment (e.g., one trade submission for each 30 minute increment). In another embodiment, the trader must submit a trade in the time increment (e.g., one trade submission for each 30 minute increment). It may be desirable for a trader to be required to trade every 30 minutes rather than trade only when the trader thinks the market conditions are optimal. Further, the trader computing devices 120a, 120b, 120c may present a user interface requiring input of a call every 10 minutes, and one of those calls must be a trade. As a result, the trading platform module 140 has access to even more data when performing analysis of traders, both in associating similar trader records and in predicting market conditions.

The submitted trade is transmitted to the trading platform module 140, where it is analyzed to determine whether the trade should be executed on the live markets and whether the trader should be given an opportunity for another trade submission. Using the clock of the trading platform server, a time elapsed during the time increment for the trader to submit a potentially profitable trade can be determined and can factor in determining the profitability of that trader in that market condition. If the trader submits a trade to the trader computing device 120a, 120b, 120c, and the trading platform module 140 determines that submitted trade is a potentially profitable trade, the trading platform module 140 will assess the market condition and may allow the trader to submit additional trades during the time increment while the market conditions are favorable to that trader.

In predetermined increments of time, the utility trading server 130 transmits a message to each of the trader computing devices 120a, 120b, 120c. In an exemplary embodiment, the increment is every 10 minutes, but any period of time may be used (e.g., 20 minutes, 30 minutes, one hour, two hours). The message comprises data representing three questions. In the exemplary embodiment, the questions can include: (a) is the market within the next increment of time (e.g., 10 minutes) trending higher or lower, (b) what do you think is the range of the market in the next increment of time (e.g., 10 minutes), and (c) are you going to place a trade in the next increment of time (e.g., 10 minutes).

When a trader is logged in to a trader computing device 120a, 120b, 120c and has an open session, the message received by the trader computing devices 120a, 120b, 120c causes the trader computing devices to generate a prompt on a graphical user interface to display these questions and present fields for input of a response. In one alternative embodiment, when the trader is logged in and has an open session on the trader computing device, the trader computing device automatically presents this graphical user interface with questions and fields at predetermined times, e.g., each time an internal clock of the trader computing device (or a clock of the trader computing device synchronized with the utility trading server) reaches a time increment. In response to question (a), the trader may input into the graphical user interface of the trader computing device that the market will be higher or lower. In response to question (b), for example, with regard to a Euro/Dollar price for a next 10 minute increment, a first trader may input a range of 1.1212 to 1.1219, while a second trader may input 1.1212 to 1.1222. In this example, the second trader is more bullish than the first trader, because the second trader is predicting a higher increase in price to 1.1222 whereas the first trader only projected a high of 1.1219. In response to question (c), the trader responds whether he/she will place a trade. If the trader is planning on placing a trade, the trader will input a market-entry price level for a proposed trade.

The responses are input into the graphical user interface. Upon entry of the three questions, the trader computing device will automatically generate a message to send to the utility trading server that includes data representative of the responses. Because the utility trading server must act on this data for this time increment, the questions on the user interface may be presented in with a limited time for response (e.g., 30 seconds). If the trader computing device does not receive the inputs from the trader and cannot transmit a message to the utility trading server within that limited time for response, then the data for that trader will not be considered in any analysis of that time increment.

The data can be stored in a record in the database 170. Database 170 can comprise a set of records for each time increment that contains data representing responses from each trader for that time increment. After the limited time for response, the utility trading server can query the database for the data of the time increment to determine when and where to enter a trade. The utility trading server analyzes the responses to determine when and where to enter a trade using a live account in a live market.

Once the utility trading server identifies an opportunity to enter a live trade, the utility trading server activates a protocol via an application program interface (API) to the live market exchange. The utility trading server relies upon numerous parameters to make this determination. As one parameter, the utility trading server analyzes the responses provided by a particular trader and determines how reliable is the prediction from that particular trader and what is the quantitative probability that the trader's prediction will make a profit. This quantification of a market call is based on characteristics of a market condition and how well it matches with characteristics of when the trader is most likely to make a profit. The trader's responses are also compared to responses of a cohort of traders that are associated with that trader at that point in time. For example, if in a market condition such as a third leg acceleration of a trending market breakout, for a selected group of 10 traders, if all of those 10 traders make the same market call, the win probability may be 98%. If the grouping of associated traders included more traders, the outcome may be considered more reliable.

A database associated with the trading platform server, such as database 170, can store a record associated with each trader. Each trader's record can be updated dynamically in real time or on a periodic basis. When the trading platform server determines which traders perform at the highest likelihood of success for a particular market condition, the records of those traders are updated with that information, and those records are then associated with each other. When the trading platform server identifies a market condition, it can query the database for all trader records that are associated with that particular market condition. Because those trader records can also associate with the demo account trades of those traders, the trading platform server can adjust the demo account trades of the selected traders records to generate an instruction to execute those demo account trades as live account trades.

The utility trading server determines a market trend using the data representing the responses from the traders. This market trend is a prediction that can be based upon behavior algorithms and fuzzy logic. The market trend prediction can also utilize biodata inputs, such as heart beat and/or blood pressure of a trader when a trade is entered (e.g. using wearable technology such as a heart rate monitor), astrology of the trader (e.g., using date of birth of the trader), and demographic information (e.g., race).

The trading platform module of the utility trading server comprises a trader behavioral analytics fuzzy inference algorithm for trader behavioral mapping and analytics and is configured to select high probability winning trades from all of the demo trades generated by the trader computing devices and copies those trades into the live market for execution. The algorithm can map different market conditions and evaluate a trader's performance in respect to the market condition that the trader is trading. For example, a trader with a 50% win rate overall may have a 87% win rate in an upchannel of 45 degrees and a channel width of 15 pips. The trading platform module can also determine market conditions using psychometric modeling and fuzzy logic functions. The trading platform module can also apply micro-algorithms within each type of market condition. The trading platform module can monitor the market microstructure as well as a price formation process, then determine the current market condition and link the determined market condition directly to a reaction of the trader. As a result, the trading platform module can optimize the system by selecting only the inputted trades from the traders having the highest likelihood of success for that particular market condition.

In predicting a market trend, the utility trading server can determine whether the market is bullish, bearish, or consolidation. For example, within a bullish market condition, the utility trading server can analyze an angle of acceleration and a bullish chart pattern for which the market is trading. Even in a consolidated market condition, the utility trading server can determine a range of consolidation and a velocity of up and down movements within a time period.

There are various metrics of data that may be included in the complete architectural framework of the system. For example, reaction times are considered for metrics such as “time taken” and “time interval.” The degree to which a trader is successful may relate to a length of the time interval between placing a winning or losing trade and the next follow-up trade. If the trader is profitable, the trades may tend to be closer together in time, whereas if the trader is loss making, the trades may tend to be further apart. The system can account for the following characteristics in determining a level of confidence of a trader: frequency of placing orders, frequency of pulling orders, time interval taken to accept a loss, time interval taken to accept a profit, use of stops, reaction time to sharp market movement, and reaction time to slow market movement.

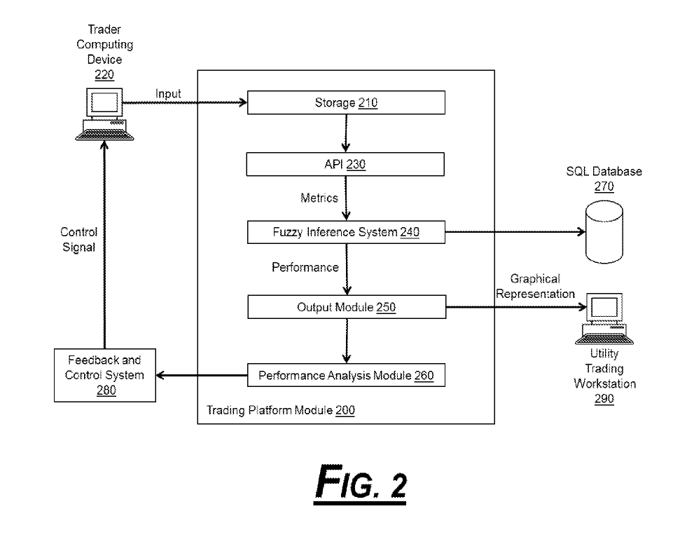

A business model key algorithm merges two concepts. First, trader behavioral analytics measures a trader's performance as a result of various factors that could affect the trader's behavior. Second, fuzzy logic utilizes artificial intelligence as a tool to help in the control complex systems by imitating the logic of human thought, which is much less rigid than the calculations computers generally perform. Due to the complexity of trader behavioral patterns due to their variable nature that makes it hard to find a mathematical model that would measure these metrics efficiently, the algorithm used by the trading platform module uses fuzzy logic to assess trader behavioral analytics. Trader behavioral analytics comprise metrics that are tied to the trader's various psychological conditions, such as emotions, personal feelings of well-being, and opinion about the market, amongst other things. These external factors can affect the traders' performance in the market (P/L Wins/Losses, Long Wins/Long Losses, etc.). These factors can also affect the traders' judgment in identifying the different market conditions, such as very bearish, bearish, sideways, bullish, very bullish, etc., as well as a degree of volatility and amount of volume on the day. Fuzzy logic is a superset of conventional (Boolean) logic that has been extended to handle the concept of partial truth and truth values between “completely true” and “completely false.” As its name suggests, it is the logic underlying modes of reasoning that are approximate rather than exact. As described below with regard to FIG. 2, the algorithm uses a fuzzy inference module that can be fed with the various behavioral analytics to produce an output showing the performance of the trader or group of traders, all of which can be saved in a database. The output can also be rendered graphically for display on a user interface for presentation to a user, and feedback can help in devising a control system to assess traders' decision-making.

The trades inputted by the traders into the trader computing devices 120a, 120b, 120c are not yet real trades that are active on the markets. Instead, these trades are first processed by the trading platform module 140 as demo trades in a demo account before the trading platform module 140 determines which trades should be transferred to a live account for transmission to the live markets. Entering the trades in a demo account can eliminate human emotions such as greed and fear.

A database, e.g., database 170, may store records associated with a demo account and a live account. All trades from the trader computing devices 120a, 120b, 120c are transmitted to the demo account for storage. Upon a dynamic determination by the trading platform module 140 that a trade should be executed on the live market, the trading platform module 140 transfers the trade from the demo account to the live account on the database. The transfer can be performed by moving a record from a first account to a second account, changing a field in a record to associate that field with a live account as opposed to a demo account, deleting a record for the demo account for the trade and generating a new record in a live account for the trade, or any other method consistent with this disclosure. The trading platform module 140 then enters the trade from the live account by automatically transmitting an instruction to a server coupled to a network of the live market.

The trading platform module has an artificial intelligence computational finance framework that can analyze data of a large number of traders, select the highest probability winning trades from all the demo trades generated by the traders, and copy those highest probability winning trades from the demo account into the live markets.

The trading platform module 140 is configured to analyze submitted trades, characteristics of the traders, and market conditions. The trading platform algorithm can determine the market conditions and evaluate each trader's performance in respect to those market conditions in which the trader is contemplating a trade. The trading platform can monitor the market microstructure as well as the price formation process, determine the current market condition and state, and link the market condition directly to the reaction of the trader. The trading platform module algorithm analyzes the received trades from each trader computing device to determine the trader's aptitude in different market conditions and the trader's trading patterns. The trading platform can analyze entries of traders based on predictive modeling and behavioral finance, i.e., analyze the aptitude of the traders in various market conditions. Based upon this analysis, a particular type of chart can be displayed on the trader computing device of each trader. The trading platform module 140 analyzes the types of traders who perform well in particular types of market environment, and if such market environment is depicted by a certain currency pair or asset class, the chart of that currency pair or asset class is presented for display on the screen of trader computing device of the trader.

The trading platform module 140 is configured to analyze trades received by the utility trading server 130. The trading platform module 140 can conduct predictive analysis for each of the trades received. In one embodiment, the trading platform module 140 can apply a threshold and only a certain percentage (e.g., 20%) of the demo trades that are most likely to be profitable (e.g., highest probability of being a winning trade) can be transmitted to live markets. The best trades can be selected from a large pool, potentially executed by thousands of traders, thereby diversifying the risk of a few traders under-performing, resulting in a more consistent return on investment. In an alternative embodiment, rather than using a percentage, a threshold can be used, whereby a predicted profitability above a certain threshold can qualify as a trade that should be transmitted to the live markets. The utility trading module 140 analyzes market moves, identifies support and resistance levels, and determines optimal entry and exit levels for high probability winning trades. The trading platform module 140 can select trades that are more likely to guarantee a high tagging win-rate and stress tests the number of traders to tag (not more than 20%, for example).

In the exemplary embodiment, the trading platform algorithm can evaluate the trader's execution and how he performs in various market conditions. In an alternative embodiment, the trading platform algorithm can identify opportunities (e.g., buy or sell a particular financial instrument) in the market, and if a trader executes one such opportunity, the trade is tagged. Hence, only if both the algorithm and the trader identifies the same opportunity, the trade will be tagged.

The performance of a trader is analyzed by the trading platform module 140. The trading platform module 140 may use the most recent submitted trade or a set of the most recently submitted trades to determine the performance of the trader. The trading platform module 140 may also use older historical data for performance of the trader under various conditions (e.g., market conditions, trader biological conditions). The trading platform module 140 attempts to determine the characteristics of a particular trader when that trader submits a profitable trade. When those trader characteristics are identified and match the present conditions of the trader and the market, the trader's submitted trades may be selected as high probability profitable trades for the live market.

One factor that may affect the success of a trader is whether the trader recently took a break. In some instances, a trader may be more profitable after a break. So the trading platform module 140 will track breaks by the trader and may execute trades submitted by a trader after the break when that trader shows more profitability after taking a break.

Another factor that may affect the success of a trader is his psychological frame of mind (e.g., level of alertness) when submitting a trade. In one embodiment, the trading platform module 140 will track game-playing by the trader and may execute trades submitted by a trader based on his performance in playing the game if it is indicative of a certain psychological frame of mind which shows more profitability.

In another example, the trading platform module 140 may look at biological conditions of the traders. Each trader may be suited with wearable technology, such as a heart rate monitor, to determine a biological condition of the trader. The trading platform module 140 may store data associated with the measured biological condition (e.g., heart rates). If a trader performs better or worse when having a particular heart rate (e.g., a heart rate above or below a certain threshold), then the trading platform module 140 will consider this performance at that heart rate when determining whether to execute the trader's demo trade on the live market. For example, when a trader performs well at a high heart rate, the trading platform module 140 may execute the trades of that trader when the trader's heart rate reaches that high level.

The trading platform module 140 can associate records of traders 170 in the database that have similar success in certain market conditions. For example, a first set of trader records may be associated because each of those traders has a high likelihood of success at Fibonacci Retracement type trading, and a second set of trader records may be associated because each of those traders has a high likelihood of success at trading Euro-Yen cross under certain market conditions. The association between the traders can be dynamically configured every 30 minutes, or in some other predetermined time increment. In determining a characteristic of a trader to use in associating records of traders, the trading platform module 140 can dynamically measure the consistency of a trader based on a matrix of algorithms.

A record of a trader can be associated with other traders for one or more market conditions. One trader may not have a high enough likelihood of success to trade in any market condition. Another trader may have a high likelihood of success in one market condition. Yet another trader may be 90% accurate when the market conditions are bullish with 67 degree of acceleration on a third leg breakout in particular for Euro-Dollar and Swiss Franc-Yen crosses, and the trader may be 80% accurate in consolidation patterns of 12 pips range.

The trading platform module 140 determines the current market conditions for the present increment of time (e.g., 10 minutes). These market conditions can be based upon the responses to the questions posed to the traders and presented on the graphical user interfaces of the trader computing devices 120a, 120b, 120c. The trading platform server 140 will determine which trade (e.g., which currencies to exchange) based on which traders are likely to have the highest probability of a winning trade. For example, if the trading platform server 140 determines that the market conditions best match the characteristics of the records associated with those traders that that are likely successful with a Euro Yen cross, then the trading platform module 140 will enter a trade on the live market based on a Euro Yen cross. As described herein, those trades are based on demo trades entered by traders and then moved into a live account once the system validates the trades for live tagging. Every 30 minutes, the trading platform module 140 dynamically determines which traders are associated with each other, a current market condition, which traders are associated with the current market condition, then selects those traders to enter trades in that 30 minute window. As a result, a productivity of the trader can be optimized and profitability can be maximized. In one embodiment, the determinations of the traders that are associated with each other, the current market condition, and the selection of the traders for that market condition can be made in advance of a trading window. For example, the trading platform module can make these determinations 10 minutes before the 30 minute window begins.

When a trader has inputted a predetermined number (e.g., three) of consecutive profitable trades, he may receive an incentive award (e.g., a monetary award). This serves to incentivize traders to submit not just isolated profitable trades but a series of successive profitable trades on a consistent basis.

The trading platform algorithm considers time taken and time interval metrics, which can be used to determine a reaction time for a trader. The degree to which a trader is successful is often observed in the length of the time interval between placing a winning or losing trade and the next follow-up trade. If the trader is profitable, the trades tend to be closer together in time, whereas if the trader is losing on these trades, then the trades tend to be further apart. As a result, the time taken and time interval metrics can affect risk management.

The trading platform algorithm may use other metrics regarding characteristics of the trader to provide insight into a trader's level of confidence: frequency of placing orders, frequency of pulling orders, time interval taken to accept a loss, time interval taken to accept a profit, use of stops, reaction time to sharp market movement, and reaction time to slow market movement. Other metrics which may be used by the trading platform algorithm include the traders' horoscope, astrology and date and time of birth.

The trading platform module 140 executes an algorithm that receives inputs of market characteristics and conditions, such as volatility, spreads, and technical indicators. The trading platform module 140 can analyze liquidity of the market to see if the quantum injected to the market can be absorbed depending on market environment.

The trading platform module algorithm evaluates when to exit from the position or trade from the analysis of the market characteristics, as well as determine an allocation of capital for each executed trade. Though the entry of a trade is replicated in a live market, the algorithm will decide when to exit the position. Upon evaluating the market conditions, a speed-based exit and trailing stop analogy can be utilized to close positions when optimal.

During the trading session of a predetermined time increment, the trading platform module 140 can determine the condition of the market and select to use the demo trades from those traders who are most likely to place profitable trades in that determined condition of the market. For example, if the market condition is upward trending, then the trading platform module 140 communicates with database 170 to obtain a listing of traders who have historically been successful in that condition. Those demo trades can be executed as live trades.

The trading platform module 140 can execute a trade from a demo account on the live market. When the trading platform module 140 determines that a trade is likely to have a high probability of profitability (i.e., likelihood that it is a winning trade), the trading platform module 140 may execute the entry of the trade according to the demo trade, but may execute a different exit strategy based upon analytics of the market conditions. For example, the trading platform module 140 may optimize the exit with a trailing position so that the exit can take advantage of a particular market condition. As a result, while the submitted demo trade may exit at 1 pip, the trading platform module 140 can maximize the return by implementing a trailing exit when the market continues to trend upwards, thereby allowing a 9 pip return. Also, while the demo trade may have been submitted with a marginal gain, the trade can be entered at a much higher value when there is more confidence in the profitability of that trade. For example, a trade may be submitted for a 1 pip profit, but the trade can be entered at an amount where the 1 pip is a greater value.

At least one investor can use an investor computing device 150 to contribute funds to the system. The investor contributes the funds with an expectation that the investor will receive the invested principal as well as a guaranteed return on the investment, e.g., 18% per annum. The funds invested by the investors through at least one investor computing device 150 is not used as capital for a trade. Instead, these funds may be leveraged by a bank or other entity. The funds may be leveraged 50 times, 100 times, 200 times, or even 1000 times the principal amount.

A speculator can use a speculator computing device 160 to invest funds. In contrast to the investor, the speculator is willing to commit invested funds to the trades. In return for the risk, the speculator expects to receive a greater return on the investment. For example, a speculator may invest $1,000 or $10,000 and expect an annual rate of return close to 30% (or 2.5% per month). The speculator invests a margin, and the speculator is accountable for a loss of that margin. The speculator does not determine how the funds are invested or what trades are executed.

The investors' contribution is used to create leverage for the trades, and the speculators' contribution is invested in the trades. The speculator can choose which trading session (e.g., which 30 minute period(s)) to invest funds, how much to invest, and a desired rate of return. This information in entered into the speculator computing device 160 and transmitted to the trading platform module 140. When the speculator wants to invest in a time increment, this action is referred to as “tagging.” The speculator enters this request in the speculator computing device 160, which transmits the tag as a message to the trading platform module 140, thereby allocating the speculator's funds to the time increment and updating a record in a database that adds the speculator to a list of entities to be paid if a profit is made upon the end of the time increment. When the trading platform module determines the end of the time increment, the trading platform module 140 allocates a profit, loss, or break-even amount to the various speculators that tagged that time increment. A speculator may desire to invest $1000 and receive a return of $100 in that time increment. The investment of $1000 may, for example, be leveraged 1000 times, resulting in a trading amount of $1 million. At $1 million, 1 pip is worth $100, so the utility trading system 110 would need to allocate 10 pip as gain for the speculator for the desired return. Upon the end of the time increment, the trading platform module 140 can allocate a profit, loss, or break-even amount to the speculator.

The trading platform module 140 may allocate a fee for each tag. For example, the trading platform module 140 may assess a 1 pip fee to a speculator when the speculator tags the utility trading system 110. In this example, if the utility trading system 110 earns a 1.5 pip fee, then the utility trading system 110 keeps 1 pip and the speculator can receive the remaining 0.5 pip. Part of the fees earned from tags by speculators may be used to pay the return to investors.

The trading platform can manage data processing, information systems analytics, and behavioral analysis and mapping. The behavior of each trader can be mapped to various metrics in the market ecosystem (i.e., market conditions). The trading platform has a trader behavioral analytics fuzzy inference system.

The trading platform combines two different features. First, the trading platform analyzes trader behavior to measure the traders' performance as a result of various factors that could affect a trader's behavior. Second, the trading platform uses a fuzzy inference system, which uses fuzzy logic that is less rigid than a binary calculation.

Trader behavioral analytics are specific metrics that can be tied to the trader's various psychological conditions, such as emotions, personal feelings of well-being, and opinion about the market, amongst other things. External factors are also found to affect the traders' performance in the market, including profit and loss, wins and losses, long wins and long losses, etc. These factors may also affect a trader's judgment in identifying the different market conditions, such as very bearish, bearish, sideways, bullish, very bullish etc., as well as the degree of volatility and amount of volume on the day.

The fuzzy inference system uses fuzzy logic, which is a superset of conventional (Boolean) logic that has been extended to handle the concept of partial truth values between “completely true” and “completely false.”

A trader behavioral analytics fuzzy inference system (TBA-FIS) is a component of the trading platform. The TBA-FIS can assess traders' performance by examining the various metrics as inputs to the system, measuring the various metrics, and providing results on which trader outperformed all the other traders. The TBA-FIS will analyze why a specific trader did better or worse than the others by providing an analysis of the different weights of the metrics. The analysis from the TBA-FIS can be used to impact and leverage the trader's decision making process in order to improve the trader's performance.

The database can store data regarding trader characteristics, trading history, demo account information, live account information, market conditions, and other information. The trading platform can query and retrieve information from the database, e.g., using a dynamic data exchange (DDE), depending on the nature of data gathering. The TBA-FIS can be provided with various behavioral analytics and will produce an output that depicts the performance of the trader or group of traders. The output from the TBA-FIS can be saved in a database. In one embodiment, the output will be illustrated graphically on screen for analysis, and this feedback can assist to assess traders' decision-making.

Referring to FIG. 2, components of a trading platform module 200 are shown according to an exemplary embodiment. The trading platform module 200 has a computer-readable storage medium 210 that can store data. Data can be inputted from a trader computing device 220. The storage 210 is communicatively coupled to a fuzzy inference system 240 using an application program interface (API) 230. Metrics from the storage 210 can be provided to the fuzzy inference system 240. The fuzzy inference system 240 is also communicatively coupled to a SQL database 270. Performance data from the fuzzy inference system 240 is transmitted to an output module 250. The output module 250 is communicatively coupled to a utility trading workstation 290, and the output module 250 can transmit the performance data for display on the utility trading workstation 290. The output module 250 is also communicatively coupled to a performance analysis module 260. The performance analysis module 260 can provide analysis of the performance data, which can be transmitted to a feedback and control system 280, which may be a component of the utility trading platform. The feedback and control system 280 transmits a control signal to the trader computing device 220 in an attempt to impact and leverage the trader's decision making.

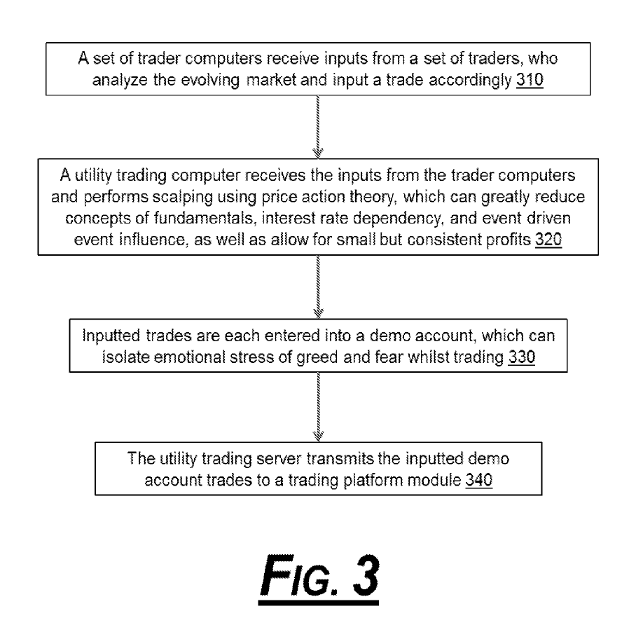

Referring to FIG. 3, an exemplary method is shown. In step 310, a set of trader computing devices receive inputs from a set of traders, who analyze the evolving market and input a trade accordingly. Due to the large set of traders, e.g., over 10,000 traders, the system can diversify the risk and trading performance is not dependent upon a small group of high performing traders. The trades can be based upon pure price action without fundamentals, which may require fewer considerations in executing the trades. The trades may also be placed in different asset classes.

In step 320, a utility trading computer receives the inputs from the trader computing devices and executes computer-readable instructions that perform scalping using price action theory, which can greatly reduce concepts of fundamentals, interest rate dependency, and event driven event influence, as well as allow for small but consistent profits.

In step 330, the inputted trades are each entered into records in a demo account, rather than a live account, which can isolate emotional stress of greed and fear while trading. Because a demo account is used rather than placing the trade on the live market for execution, a trade can be submitted more objectively and may be inputted with less fear and greed.

In step 340, the utility trading server transmits the inputted demo account trades to a trading platform module, which automatically analyzes market conditions and matches those conditions to trader records having characteristics where that trader performs well in those selected market conditions.

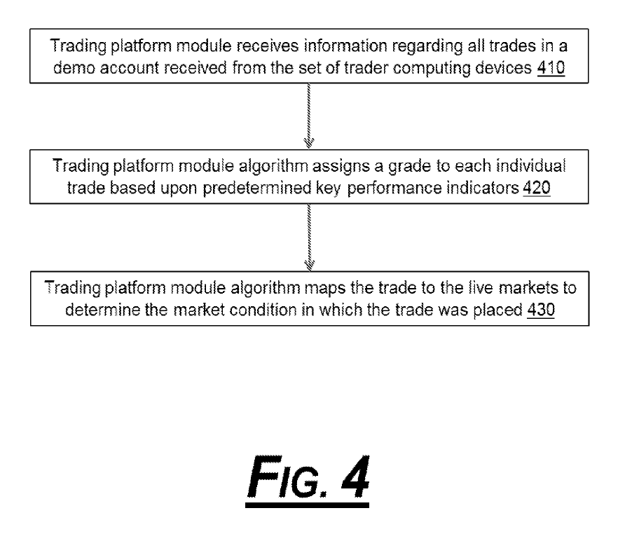

As shown in FIG. 4, a trading platform module algorithm can be executed as follows. In step 410, the trading platform module receives information regarding all trades in the demo account received from the set of trader computers.

In step 420, the trading platform module algorithm assigns a grade to each individual trade based upon predetermined key performance indicators, including but not limited to: profit, holding time, marked to market losses, and take profit ratio. These grades can be used to segment the traders.

In step 430, the trading platform module algorithm maps the trade to the live markets to determine the market condition in which the trade was placed. For example, even though a trader may have an average rate of 60%, it is possible that the trader has an 85% win rate in an up-channel of 35 degrees and a volatility of 15 pips. The mapping can be performed after the trader has placed a substantial number of trades in the system following a trade plan and rules of price action trading.

As described above, the trading platform module algorithm can evaluate a set of trades inputted by a trader to determine how the trader performs in various market conditions. In an alternative embodiment, the trading platform module algorithm can identify opportunities in the market and if a trader executes on an identified opportunity, then the trade will be executed in the live market. In one embodiment, a trade will be executed if both the algorithm and the trader identify the same opportunity.

In an exemplary process, a trader aims to make a small and consistent profit and aims to precisely time entry and exit levels. The trader enters the trade on a trader computing device, and all trades are closed within 90 seconds. The trades are executed on demo accounts to isolate the traders from the emotional factors associated with trading, such as greed and fear.

A trading platform uses an algorithm and big data analytics to map the characteristics of the traders when they perform best with the market conditions so that the trading platform can select the highest-probability winning trades for a live market. When the trading platform enters the highest-probability winning trades, the trading platform is more likely to receive positive returns. When the trading platform receives positive returns, those speculators that tagged the trading platform for that trading session can also receive positive returns.

Although certain illustrative, non-limiting exemplary embodiments have been presented, various changes, substitutions, permutations, and alterations can be made without departing from the scope of the appended claims. Further, the steps of the methods described herein may be carried out in any suitable order, or simultaneously where appropriate. Thus, the scope of the invention should not necessarily be limited by this description. The scope of the present invention is instead defined by the following claims.

Unless specifically stated otherwise as apparent from the following discussion, it is appreciated that throughout the description, discussions utilizing terms such as “processing,” “computing,” “transmitting,” “receiving,” “determining,” “displaying,” “identifying,” “presenting,” “establishing,” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices. The system or portions thereof may be installed on an electronic device.

The exemplary embodiments can relate to an apparatus for performing one or more of the functions described herein. This apparatus may be specially constructed for the required purposes, or it may comprise a computer selectively activated or reconfigured by a computer program stored in the computer. Such a computer program may be stored in a machine (e.g. computer) readable storage medium, such as, but is not limited to, any type of disk including floppy disks, optical disks, CD-ROMs and magnetic-optical disks, read only memories (ROMs), random access memories (RAMs) erasable programmable ROMs (EPROMs), electrically erasable programmable ROMs (EEPROMs), magnetic or optical cards, or any type of media suitable for storing electronic instructions, and each coupled to a bus.

The exemplary embodiments described herein are described as software executed on at least one server, though it is understood that embodiments can be configured in other ways and retain functionality. The embodiments can be implemented on known devices such as a personal computer, a special purpose computer, cellular telephone, personal digital assistant (“PDA”), a digital camera, a digital tablet, an electronic gaming system, a programmed microprocessor or microcontroller and peripheral integrated circuit element(s), and ASIC or other integrated circuit, a digital signal processor, a hard-wired electronic or logic circuit such as a discrete element circuit, a programmable logic device such as a PLD, PLA, FPGA, PAL, or the like. In general, any device capable of implementing the processes described herein can be used to implement the systems and techniques according to this invention.

The exemplary embodiments can relate to an apparatus for performing one or more of the functions described herein. This apparatus may be specially constructed for the required purposes and/or be selectively activated or reconfigured by computer executable instructions stored in non-transitory computer memory medium.

It is to be appreciated that the various components of the technology can be located at distant portions of a distributed network and/or the Internet, or within a dedicated secured, unsecured, addressed/encoded and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The term “module” as used herein can refer to any known or later developed hardware, software, firmware, or combination thereof that is capable of performing the functionality associated with that element.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Presently preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method comprising:
receiving, by a server, an input transmitted from each of a plurality of trader computing devices comprising a message having data representing a prediction of a market trend and a proposed trade, wherein the input is transmitted within a predetermined time increment;
storing, by the server, each proposed trade in a record of a demo account in a database communicatively coupled to the server, wherein the proposed trade is associated in the record with a trader and the time increment;
determining, by the server, a likelihood that the received prediction is correct and a current market condition for the time increment;
dynamically selecting, by the server, a set of records in the demo account associated with each trader that has a likelihood above a threshold amount for a profitable trade in the determined market condition and based upon the likelihood that the received prediction is correct and historical behavioral data of each trader;
automatically adjusting, by the server, the record of the proposed trade in the demo account to a trade in a live account for executing in a market; and
generating, by the server, an instruction to execute the trade from the live account.

2. The computer-implemented method according to claim 1, wherein the threshold amount comprises the most profitable 20% of the trades.

3. The computer-implemented method according to claim 1, further comprising:
establishing, by the server, a trading session having the time increment; and
limiting, by the server, a number of trades submitted by each trader during the trading session having the time increment.

4. The computer-implemented method according to claim 3, wherein the time increment is 30 minutes.

5. The computer-implemented method according to claim 3, wherein the number of trades is one.

6. The computer-implemented method according to claim 1, wherein the plurality of trader computing devices comprises at least 10,000 trader computing devices.

7. The computer-implemented method according to claim 1, wherein computing the probability comprises:
identifying, by the server, a biological condition of each trader;
identifying, by the server, a set of characteristics of each trader when that trader has a high probability of making a profitable trade, wherein the set of characteristics comprises at least one biological condition;
storing, by the server, a record of the set of characteristics of each trader when that trader has a high probability of making a profitable trade; and
determining, by the server, whether the identified biological condition matches the biological condition in the record of the set of characteristics.

8. The computer-implemented method according to claim 1, wherein determining the likelihood that the received prediction is correct and the current market condition for the time increment comprises applying a fuzzy logic algorithm.

9. The computer-implemented method according to claim 1, wherein determining the likelihood and dynamically selecting the set of records both occur once during each predetermined time increment.

10. The computer-implemented method according to claim 1, wherein the predetermined time increment is 10 minutes.

11. The computer-implemented method according to claim 1, wherein the predetermined time increment is 30 minutes.

12. The computer-implemented method according to claim 1, whereby the server determines the current market condition based on the input transmitted from each of a plurality of trader computing devices.

13. A computer-implemented method comprising:
determining, by a server, characteristics of each of a plurality of traders to determine characteristics of each of the plurality of traders when those traders have the highest probability of entering a profitable trade;
determining, by the server, a present market condition;
analyzing, by the server, which trader of the plurality of traders has the highest probability of entering a profitable trade in the determined present market condition;
automatically presenting, by the server, a set of data in at least three timeframes for display on a graphical user interface of a trader computing device;
receiving, by the server, an input of data representing a trade from each of a plurality of trader computers;
dynamically selecting, by the server, a subset of the plurality of traders for entering live trades based on the trade inputted from the trader computers when the determined present market condition matches characteristics of the subset of the plurality of traders; and
generating and transmitting, by the server, an instruction to enter the live trades.

14. The computer-implemented method according to claim 13, further comprising:
entering, by the server, a percentage of the received trades that are determined to have the highest probability of being a profitable trade.

15. The computer-implemented method according to claim 13, further comprising:
establishing, by the server, a trading session having a time increment; and
limiting, by the server, a number of trades submitted by each trader during the trading session having the time increment.

16. The computer-implemented method according to claim 15, wherein the time increment is 30 minutes.

17. The computer-implemented method according to claim 15, wherein the number of trades is one.

18. The computer-implemented method according to claim 14, wherein the plurality of trader computing devices comprises at least 10,000 trader computing devices.

19. The computer-implemented method according to claim 13, wherein analyzing comprises:
identifying, by the server, a biological condition of each trader;
identifying, by the server, a set of characteristics of each trader when that trader has a high probability of making a profitable trade, wherein the set of characteristics comprises at least one biological condition;
storing, by the server, a record of the set of characteristics of each trader when that trader has a high probability of making a profitable trade; and
determining, by the server, whether the identified biological condition matches the biological condition in the record of the set of characteristics.

20. A computer-implemented method comprising:
determining, by a server, a subset of a set of trades inputted during a trading session of a predetermined time increment that have a high probability of being a profitable trade in a particular market condition;
receiving, by the server, a message from at least one speculator computing device to commit funds of a speculator for the trading session having the subset of the set of trades;
entering, by the server, the subset of the set of trades in a market;
computing, by the server, a profit or loss for the subset of the set of trades entered in the market; and
automatically allocating, by the server, the profit or loss for the subset of the set of trades to the at least one speculator based upon the funds committed by the speculator.

21. The computer-implemented method according to claim 20, further comprising:
receiving, by a server, a transmission from each of a plurality of trader computing devices comprising a trade for a financial instrument, wherein the trade from each of the plurality of trader computing devices collectively forms a set of trades;
analyzing, by the server, which trader of the plurality of traders has the highest probability of entering a profitable trade in a determined present market condition; and
forming, by the server, the subset of trades based on the trades from each of the plurality of traders that has the highest probability of entering a profitable trade.
